(19) United States
(12) Patent Application Publication
(10) Pub. No.: US 2013/0271863 A1
(43) Pub. Date: Oct. 17, 2013

(54) FLYCUTTING GROOVE MACHINING METHOD AND FLYCUTTING MIRROR FINISHING METHOD ON FILM-LIKE WORKPIECE

(71) Applicant: TOSHIBA KIKAI KABUSHIKI KAISHA, Tokyo-to (JP)

(72) Inventor: Takashi SHIMANUKI, Numazu-shi (JP)

(73) Assignee: Toshiba Kikai Kabushiki Kaisha, Tokyo-to (JP)

(21) Appl. No.: 13/863,067

(22) Filed: Apr. 15, 2013

(30) Foreign Application Priority Data
Apr. 16, 2012 (JP) 2012-093307

(51) Int. Cl. B26D 1/01; G02B 5/08

(52) U.S. Cl. CPC B26D 1/015; G02B 5/08
USPC 359/838; 83/875

(57) ABSTRACT

The present invention is a flycutting mirror finishing method on a film-like workpiece, comprising: mounting a flycutting jig, on which a flycutting tool has been mounted, on a rotary spindle; and controlling a rotation of the rotary spindle and a position of the film-like workpiece relative to the rotary spindle; wherein, in order that the flycutting tool forms a mirror surface on a side edge surface of the film-like workpiece, the position of the film-like workpiece relative to the rotary spindle is moved in parallel with the mirror surface.

### CROSS REFERENCE TO RELATED APPLICATIONS

This application is based upon and claims the benefit of priority from the prior Japanese Patent Application No. 2012-93307 filed on Apr. 16, 2012, the entire contents of which are incorporated herein by reference.

### FIELD OF THE INVENTION

The present invention relates to a flycutting groove machining method and a flycutting mirror finishing method on a film-like workpiece.

### BACKGROUND ART

A machining method called “flycutting” has been conventionally known. In this machining method, a high-precision turning tool (machining tool) is mounted on a flange, where the turning tool is widely rotated by rotating the flange so that a material on a surface to be machined of a workpiece is flew out (ground out/shaved off) with each rotation, whereby the workpiece is cut. This machining method is mainly used in machining convex lenses.

On the other hand, members for optical communication equipped with a groove for an optical waveguide are widely used. The member is formed by filling a “mold” with a resin, by a generally employed molding method (see JP2004-163914A). This is because there is no high-precision method for cutting a “groove” in the member.

Even a cutting method using a diamond blade, which is generally regarded as a high-precision method, has a problem of generating “burrs”, and thus does not achieve the precision (mirror-like precision) required for optical components.

The inventor of the present invention has found that, by subjecting a film-like workpiece to a machining method referred to as “flycutting”, a “groove” can be formed therein with an extremely high precision. In addition, the inventor of the present invention has found that edge surfaces that have been subjected to the flycutting method are so precise that the edge surfaces can be used as mirror surfaces.

The present invention is based on the above findings. The object of the present invention is to provide a method of machining a groove by flycutting in a film-like workpiece. Alternatively, the object of the present invention is to provide a method for finishing a mirror surface by flycutting on a film-like workpiece.

### SUMMARY OF THE INVENTION

The present invention is a flycutting mirror finishing method on a film-like workpiece, comprising: mounting a flycutting jig, on which a flycutting tool has been mounted, on a rotary spindle; and controlling a rotation of the rotary spindle and a position of the film-like workpiece relative to the rotary spindle; wherein, in order that the flycutting tool forms a mirror surface on a side edge surface of the film-like workpiece, the position of the film-like workpiece relative to the rotary spindle is moved in parallel with the mirror surface.

According to the actual test conducted by the inventor of the present invention, it was found that the present invention can produce an extremely high-precision groove shape and an extremely high-precision mirror surface on a side edge surface of a film-like workpiece, without a problem of generating “burrs”. In addition, unlike when a diamond blade is used, it is not necessary to supply a liquid for cooling the blade and/or removing a workpiece dust (the present invention can be carried out under dry conditions). Thus, the present invention can be carried out at a low running cost in an eco-friendly manner.

A film-like workpiece such as a metal foil, a metal film or a resin film can demonstrate the effect. For example, the metal includes gold, silver, copper, tin, nickel, etc., and the resin includes a synthetic resin such as an acryl-based resin, a polysilane-based resin, an epoxy-based resin a norbornene-based resin and a polyimide-based resin. A film-like workpiece having a resin substrate and a metal foil or a metal film thereon can also provide the same effect.

Preferably, the flycutting tool includes a monocrystal diamond tool and a metal shank. In addition, preferably, a distal end of the monocrystal diamond tool has an angle of 45 degrees. In addition, the flycutting jig is generally a flycutting flange.

In addition, preferably, the present invention further includes supplying air to a machining area. Due to this step, the flycutting tool can be effectively cooled and workpiece dust can be blown out and removed. In addition, more preferably, the present invention further includes sucking air in a machining area. Due to this step, the workpiece dust can be effectively eliminated.

Alternatively, the present invention is a flycutting groove machining method on a film-like workpiece, comprising: mounting a flycutting jig, on which a flycutting tool has been mounted, on a rotary spindle; and controlling a rotation of the rotary spindle and a position of the film-like workpiece relative to the rotary spindle; wherein, in order that the flycutting tool forms a linear recessed groove in the film-like workpiece, the position of the film-like workpiece relative to the rotary spindle is moved in a direction in which the recessed groove is to extend.

According to the actual test conducted by the inventor of the present invention, it was found that the present invention can produce an extremely high-precision recessed groove in a film-like workpiece, without a problem of generating “burrs”. In addition, unlike when a diamond blade is used, it is not necessary to supply a liquid for cooling the blade and/or removing a workpiece dust (the present invention can be carried out under dry conditions). Thus, the present invention can be carried out at a low running cost in an eco-friendly manner.

A film-like workpiece such as a metal foil, a metal film or a resin film can demonstrate the effect. For example, the metal includes gold, silver, copper, tin, nickel, etc., and the resin includes a synthetic resin such as an acryl-based resin, a polysilane-based resin, an epoxy-based resin a norbornene-based resin and a polyimide-based resin. A film-like workpiece having a resin substrate and a metal foil or a metal film thereon can also provide the same effect.

Preferably, the flycutting tool includes a monocrystal diamond tool and a metal shank. In addition, preferably, a distal end of the monocrystal diamond tool has an angle of 45 degrees. In addition, the flycutting jig is generally a flycutting flange.

In addition, preferably, the present invention further includes supplying air to a machining area. Due to this step, the flycutting tool can be effectively cooled and workpiece dust can be blown out and removed. In addition, more preferably, the present invention further includes sucking air in a machining area. Due to this step, the workpiece dust can be effectively eliminated.

An optical component having a high-precision mirror surface or a high-precision groove produced by the aforementioned respective methods is also the subject matter of the present invention.

### BRIEF DESCRIPTION OF THE DRAWINGS

FIG. 1 is a schematic view showing a flycutting tool and a flycutting flange, for realizing a flycutting groove machining method on a film-like workpiece in one embodiment of the present invention;

FIG. 2 is a schematic view for explaining the flycutting groove machining method on a film-like workpiece in the embodiment of the present invention; and

FIG. 3 is a schematic view for explaining a flycutting mirror finishing method on a film-like workpiece in another embodiment of the present invention.

### DETAILED DESCRIPTION OF THE INVENTION

Embodiments of the present invention will be described herebelow with reference to the attached drawings.

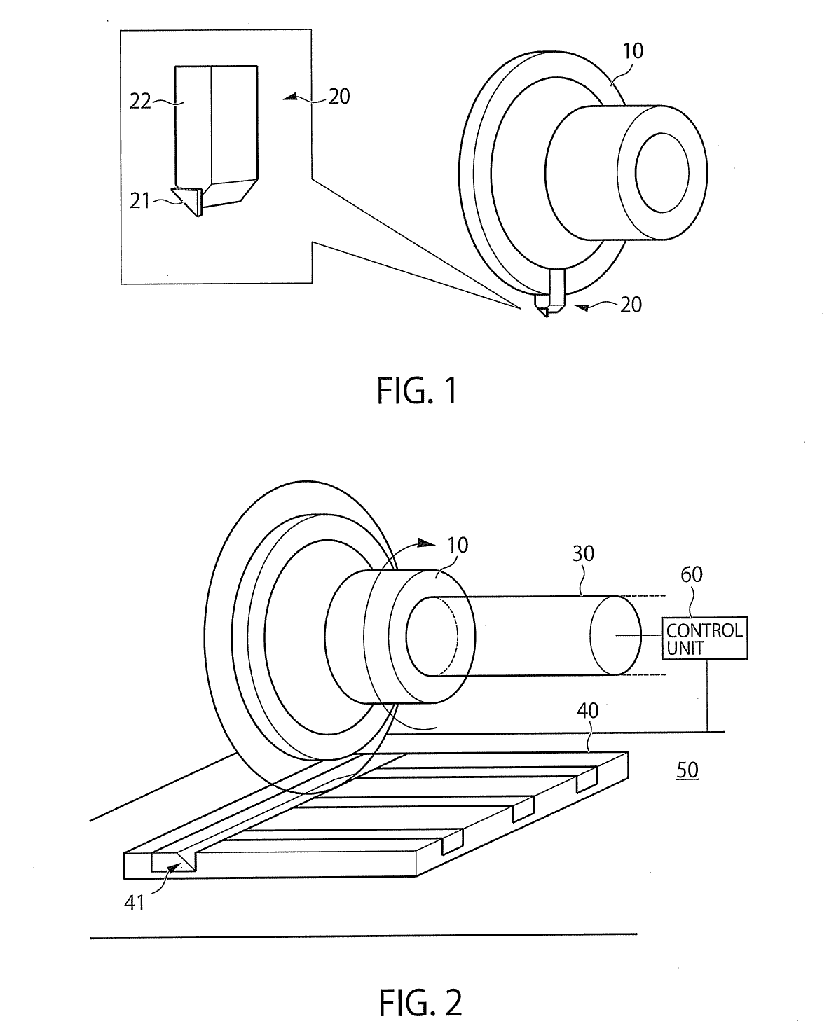

FIG. 1 is a schematic view showing a flycutting tool and a flycutting flange, for realizing a flycutting groove machining method on a film-like workpiece in one embodiment of the present invention. FIG. 2 is a schematic view for explaining the groove machining method.

As shown in FIG. 1, in this embodiment, a flycutting flange 10 is employed as a flycutting jig to be mounted on a rotary spindle. A flycutting tool 20 is mounted on the flycutting flange 10. The flycutting tool 20 is also referred to as “angled cutter”, and is composed of a monocrystal diamond tool 21 and a metal shank 22 in this embodiment. The monocrystal diamond tool 21 and the metal shank 22 are fixed to each other by brazing.

As shown in FIG. 1, the monocrystal diamond tool 21 in this embodiment is formed of a tool of a triangular type, with a distal end thereof having an angle of 45 degrees. However, the monocrystal diamond tool 21 may be a tool of an obtuse triangle type or a rectangular type. To be exact, the distal end of the monocrystal diamond tool 21 has a radius. Furthermore, in place of the monocrystal diamond tool 21, a polycrystal diamond tool may be used. Alternatively, a carbide tool or a CBN tool may be used.

As shown in FIG. 2, a film-like workpiece 40 is placed on a worktable 50, and the flycutting flange 10 is secured on a rotary spindle 30 of, e.g., a USM (Ultra Slicing Machine). By rotating the rotary spindle 30, the distal end of the monocrystal diamond tool 21 is moved along a wide rotation trajectory so as to fly out a surface to be machined of the film-like workpiece 40 with each rotation.

The rotation of the rotary spindle 30 and the position of the worktable 50 relative to the rotary spindle 30 are controlled by a control unit 60. To be specific, in order that the monocrystal diamond tool 21 forms a linear recessed groove 41 in the film-like workpiece 40, the position of the worktable 50 relative to the rotary spindle 30 is moved in a direction in which the recessed groove 41 is to extend.

According to the above machining method in this embodiment, the extremely high-precision recessed groove 41 could be produced in the film-like workpiece 40, without a problem of generating “burrs”. Specifically, since the monocrystal diamond tool 21 of a triangular type, with a distal end thereof having an angle of 45 degrees, was used, a V-shaped groove having a triangular cross-section could be produced highly precisely. In particular, since the slant surface of the recessed groove 21, which is at 45 degrees relative to the horizontal direction, can function as a reflection surface (mirror surface) that vertically reflects horizontal light, the film-like workpiece 40 can be developed as various optical components. For example, the slant surface of the recessed groove 21 can be applied as a reflection surface of a VCSEL (Vertical Cavity Surface Emitting Laser) or a VECSEL (Vertical External Cavity Surface Emitting Laser).

In addition, unlike when a diamond blade is used, it is not necessary to supply a liquid for cooling the blade and/or removing a workpiece dust (this embodiment can be carried out under dry conditions). Thus, this embodiment can be carried out at a low running cost in an eco-friendly manner.

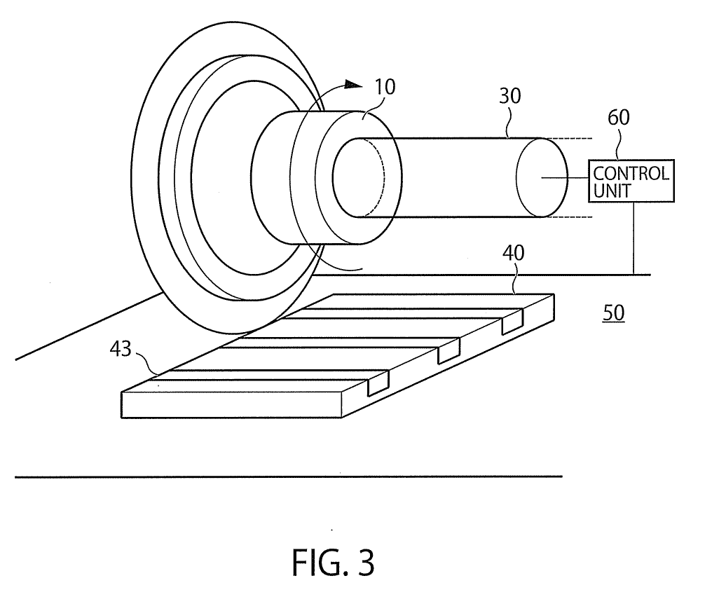

Next, FIG. 3 is a schematic view for explaining a flycutting mirror finishing method on a film-like workpiece. Also in this method, the flycutting tool 20 and the flycutting flange 10 are used, but an object to be machined is not a groove in an upper surface of the film-like workpiece 40 but a mirror surface on a side edge surface of the film-like workpiece 40.

Also in this method, as shown in FIG. 3, the film-like workpiece 40 is placed on the worktable 50, and the flycutting flange 10 is secured on the rotary spindle 30. By rotating the rotary spindle 30, the distal end of the monocrystal diamond tool 21 is moved along a wide rotation trajectory so as to fly out a surface to be machined of the film-like workpiece 40 with each rotation.

The rotation of the rotary spindle 30 and the position of the worktable 50 relative to the rotary spindle 30 are also controlled by the control unit 60. In order that the monocrystal diamond tool 21 forms a mirror surface 43 on an edge surface of the film-like workpiece 40, the position of the worktable 50 relative to the rotary spindle 30 is moved in parallel with this edge surface (mirror surface).

According to the above machining method in this embodiment, the extremely high-precision mirror surface 43 could be produced on the film-like workpiece 40, without a problem of generating “burrs”. Since the mirror surface 43 can receive incident light that is vertical thereto with extremely low loss (this holds true with emergent light), the film-like workpiece 40 can be developed as various optical components.

In addition, unlike when a diamond blade is used, it is not necessary to supply a liquid for cooling the blade and/or removing a workpiece dust (this embodiment can be carried out under dry conditions). Thus, this embodiment can be carried out at a low running cost in an eco-friendly manner.

1. A flycutting mirror finishing method on a film-like workpiece, comprising:
mounting a flycutting jig, on which a flycutting tool has been mounted, on a rotary spindle; and
controlling a rotation of the rotary spindle and a position of the film-like workpiece relative to the rotary spindle;
wherein, in order that the flycutting tool forms a mirror surface on a side edge surface of the film-like workpiece, the position of the film-like workpiece relative to the rotary spindle is moved in parallel with the mirror surface.

2. The flycutting mirror finishing method on a film-like workpiece according to claim 1, wherein
the film-like workpiece contains a metal foil or a metal film.

3. The flycutting mirror finishing method on a film-like workpiece according to claim 1, wherein
the film-like workpiece contains a resin.

4. The flycutting mirror finishing method on a film-like workpiece according to claim 1, wherein
the flycutting tool includes a monocrystal diamond tool.

5. The flycutting mirror finishing method on a film-like workpiece according to claim 1, further comprising supplying air to a machining area.

6. The flycutting mirror finishing method on a film-like workpiece according to claim 1, further comprising sucking air in a machining area.

7. A flycutting groove machining method on a film-like workpiece, comprising:
mounting a flycutting jig, on which a flycutting tool has been mounted, on a rotary spindle; and
controlling a rotation of the rotary spindle and a position of the film-like workpiece relative to the rotary spindle;
wherein, in order that the flycutting tool forms a linear recessed groove in the film-like workpiece, the position of the film-like workpiece relative to the rotary spindle is moved in a direction in which the recessed groove is to extend.

8. The flycutting groove machining method on a film-like workpiece according to claim 7, wherein
the film-like workpiece contains a metal foil or a metal film.

9. The flycutting groove machining method on a film-like workpiece according to claim 7, wherein
the film-like workpiece contains a resin.

10. The flycutting groove machining method on a film-like workpiece according to claim 7, wherein
the flycutting tool includes a monocrystal diamond tool.

11. The flycutting groove machining method on a film-like workpiece according to claim 7, further comprising supplying air to a machining area.

12. The flycutting groove machining method on a film-like workpiece according to claim 7, further comprising sucking air in a machining area.

13. An optical component having a mirror surface formed by the flycutting mirror finishing method on a film-like workpiece according to claim 1.

14. An optical component having a groove formed by the flycutting groove machining method on a film-like workpiece according to claim 7.
